(19) United States
(12) Patent Application Publication
(10) Pub. No.: US 2003/0133553 A1
(43) Pub. Date: Jul. 17, 2003

(54) Method and apparatus for delivering enhanced caller identification services to a called party

(76) Inventors: Shabbir A. Khakoo, Morganville, NJ (US); Venkatesh Krishnaswamy, Holmdel, NJ (US); Anwar A. Siddiqui, New York, NY (US); Hal B. Zenner, Fair Haven, NJ (US)

Correspondence Address: Ryan, Mason & Lewis, LLP, Suite 205, 1300 Post Road, Fairfield, CT, 06430, US

(21) Appl. No.: 10/261,242

(22) Filed: Sep. 30, 2002

Related U.S. Application Data
(60) Provisional application No. 60/348,680, filed on Jan. 15, 2002.

(51) Int. Cl. H04M 1/56; H04M 15/06

(52) U.S. Cl. 379/142.01; 379/142.06; 379/142.07

(57) ABSTRACT

A method and apparatus are disclosed for delivering enhanced caller identification services to a called party. Caller ID information is extended to include a user document address that is a pointer or hyperlink to a user document containing additional information about the calling party. The user document address may be, for example, a uniform resource locator (URL) identifying an Internet document or a database address identifying a database document or entry. The user document generally contains information that the calling party would like to be presented to the called party and may be stored by the called party or accessed over a network. The user document can be (i) a static document; (ii) a document created in accordance with predefined default document content rules; or (iii) a dynamically generated document based on one or more rules that alter the content of the document.

### CROSS REFERENCE TO RELATED APPLICATIONS

This application claims the benefit of U.S. Provisional Application No. 60/348,680, filed Jan. 15, 2002.

### FIELD OF THE INVENTION

The present invention relates generally to communication networks, and more particularly, to methods and systems for delivering enhanced caller identification services to a called party.

### BACKGROUND OF THE INVENTION

Modern telephone systems generally provide a caller identification feature for identifying the calling party. Caller ID services have become very popular with both residential and business customers. Caller ID services are especially valuable to businesses that use caller ID information to access customer records associated with an incoming call or to route an incoming call to specific customer representatives based on characteristics of the caller, such as a geographic location of the caller. In addition, residential customers frequently employ the caller ID feature to screen unwanted incoming calls.

Generally, customers register for a caller ID service with their telephone service provider. Typically, the customer is connected to the facilities of a service provider through a central office switch. If a called party subscribes to the caller ID service, information about the caller is automatically displayed on a display associated with the telephone of the called party whenever a call is received.

The information displayed about the caller is typically limited to the caller's name or telephone number (or both). U.S. Pat. No. 5,771,283 to Chang et al., entitled “Method for Delivering Enhanced Caller Identification Service in a Telecommunications Network,” discloses a method for delivering enhanced caller identification services to a subscriber. Chang et al. extend the conventional caller ID feature to include information about the geographic location of the caller. Generally, if a called party subscribes to the enhanced caller ID service proposed by Chang et al., the directory number of the calling party is supplemented with geographic identification data associated with the originating switch, so that the true geographic location of the caller can be ascertained.

U.S. Pat. No. 6,192,116 to Mayak, entitled “System and Method for Generating CID/CIDCW Information With a User Inputted Message,” discloses a technique for extending the caller ID information to include a message provided by the user. A central office receives a message from the calling party and attaches the user message to the caller ID information to produce a destination message that is displayed to the called party. The user message is typically of a limited size that must not exceed the limitations of the caller ID service, such as 255 bytes. Frequently, however, it would be desirable to provide additional information about the calling party to the called party or to automatically tailor the provided information to characteristics of the called party. A need therefore exists for a method and apparatus for delivering enhanced caller identification services to a called party.

### SUMMARY OF THE INVENTION

Generally, a method and apparatus are disclosed for delivering enhanced caller identification services to a called party. The present invention extends the caller ID information that is presented to a called party to include a user document address that is a pointer or hyperlink to a user document containing additional information about the calling party. The user document address may be, for example, a uniform resource locator (URL) identifying an Internet document or a database address identifying a database document or entry. Thus, the present invention provides a convenient mechanism for providing desired additional information to a called party without exceeding the data constraints of conventional caller ID systems.

The user document referenced by the address included with the caller ID information generally contains information that the calling party would like to be presented to the called party and may be stored by the called party or accessed over a network, such as a web page that may be accessed over the Internet. The user document can be (i) a static document created, for example, by or on behalf of the calling party; (ii) a default document created, for example, in accordance with predefined document content rules; or (iii) a dynamically generated document based on one or more rules that alter the content of the document based on various characteristics of the called party or the call (or both).

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 is a schematic block diagram of an exemplary switch incorporating features of the present invention;

FIG. 3 illustrates an exemplary signal transmitted from the calling party to the switch in accordance with one embodiment of the present invention;

FIG. 4 illustrates an exemplary signal transmitted by the switch to the telephone of the called party in accordance with one embodiment of the present invention;

FIG. 5 is a flow chart describing an exemplary enhanced caller ID handling process implemented by the switch of FIG. 1; and

FIG. 6 illustrates the manner in which the user document address of the present invention is processed by the called party.

### DETAILED DESCRIPTION

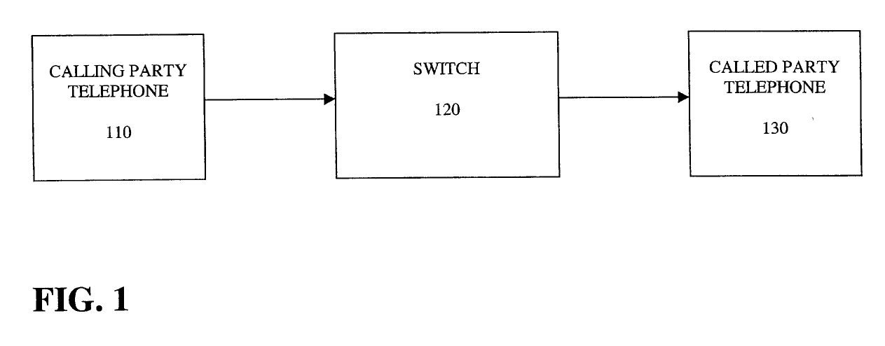

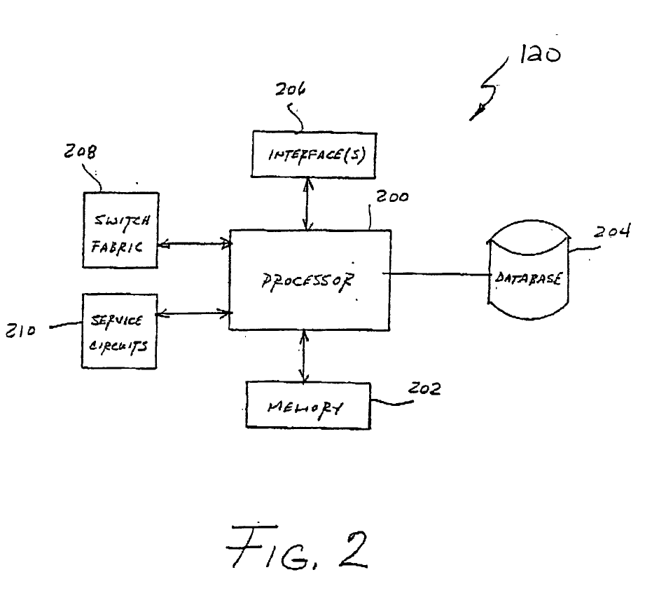

FIG. 1 illustrates an exemplary network environment in which the present invention can operate. As shown in FIG. 1, a calling party 110 calls a called party 130 and the call is routed through at least one switch 120, discussed below in conjunction with FIG. 2. According to one aspect of the present invention, the caller ID information that is presented to the called party 130 is extended to include a user document address that is a pointer or hyperlink to a user document containing additional information about the calling party 110 that may be accessed over a network, such as a web page that may be accessed over the Internet. Thus, the user document address may be, for example, a uniform resource locator (URL) identifying an Internet document or a database address identifying a database document or entry.

The document identified by the user document address contains appropriate information that the calling party 110 would like to be presented to the called party 130, for example, on the telephone of the called party 130 or an associated computing device or display, such as a personal computer or personal digital assistant (PDA). The user document may include text, images or audio or any combination of the foregoing. As discussed herein, the present invention is particularly suitable for use with available and emerging Internet technologies, such as the hypertext transfer protocol (HTTP) or a similar Internet protocol for accessing documents, voice over IP (VoIP) or the Session Initiation Protocol (SIP), described, for example, in M. Handley et al., “SIP: Session Initiation Protocol,” RFC 2543 (March 1999). The user document address may also be a link to presence information of the calling party 110, such as information recorded in a SIP registry, or a virtual business card, voice mailbox or calendar of the calling party 110.

While the present invention is illustrated below in conjunction with the processing of calls in an exemplary enterprise communication system, it is not limited to use with any particular configuration of system elements or communication processing application. Those skilled in the art will recognize that the disclosed techniques may be used in any communication system application in which it is desirable to provide enhanced caller ID information to a called party 130. Thus, the term “switch” as used herein should be understood to include a private-branch exchange (PBX) system, an enterprise switch, or other type of telecommunications system switch, as well as other types of processor-based communication control devices. The term “call” as used herein is intended to include not only incoming or outgoing telephone calls but also non-telephonic communications such as data transmissions, voice-over-IP, e-mail or facsimile.

FIG. 2 is a schematic block diagram of an exemplary switch 120 incorporating features of the present invention. The switch 120 may be embodied, for example, as a DEFINITY® Enterprise Communication Service (ECS) communication system switch, available from Avaya Inc. of Basking Ridge, N.J., USA, as modified herein to provide the features and functions of the present invention. While the present invention is illustrated in the context of a SIP-enabled switch 120, other types of known switches may be utilized, as modified herein to support the features and functions of the present invention. In particular, such known switches must be extended to support the direction of a calling party's document address identifier to the called party 130 with a call in accordance with the present invention. The conventional aspects of such switches are well known in the art and therefore not described in detail herein. The switch 120 may be connected to one or more external endpoints, e.g., external terminals or system processing elements, via a network (not shown) or other suitable communication channel(s).

As shown in FIG. 2, the exemplary switch 120 includes a processor 200, a memory 202, a database 204, one or more interfaces 206, a switch fabric 208, and a set of service circuits 210. The processor 200 may be implemented as a central processing unit (CPU), microprocessor, application-specific integrated circuit (ASIC) or other type of digital data processor, as well as various portions or combinations of such elements. The memory 202 may be a random access memory (RAM), a read-only memory (ROM) or combinations of these and other types of electronic memory devices.

The processor 200 operating in conjunction with the memory 202 executes one or more software programs for providing processing and other functions within the switch 120. Such programs may be stored in memory 202 or another storage device accessible to the switch 120 and executed by processor 200 in a conventional manner.

The database 204 may be, e.g., an optical or magnetic disk-based storage device, or other conventional storage device associated with or otherwise accessible to the switch 120. The database 204 may be used to store, e.g., feature assignments to particular feature buttons or codes, directory number assignments to corresponding call appearances or direct facility termination keys, access restrictions, and other administrative information regarding the configuration of the system, as well as other types of information. The service circuits 210 may include tone generators, announcement circuits, etc. These circuits and the interfaces 206 are controlled by processor 200 in implementing call processing functions in the switch 120.

The switch 120 may include additional elements that are omitted from FIG. 2 for simplicity and clarity of illustration. For example, the switch may include a port card for each type of user terminal associated therewith. In addition, it will be appreciated by those skilled in the art that the switch 120 may be configured to support multiple user terminals of different types, e.g., wired deskset terminals, wireless deskset terminals, personal computers, video telephones or other advanced terminals, etc. Also associated with the switch 120 may be an administrator terminal (not shown) that is used to program the operation of the switch 120 during a system administration, e.g., an initial set-up and configuration of the system or a subsequent system-level or user-level reconfiguration.

Other devices not shown in the figures may be associated with the switch 120, such as an adjunct feature server. Such an adjunct may be physically incorporated within the switch, and may be partially or completely implemented using other switch elements such as processor 200 and memory 202.

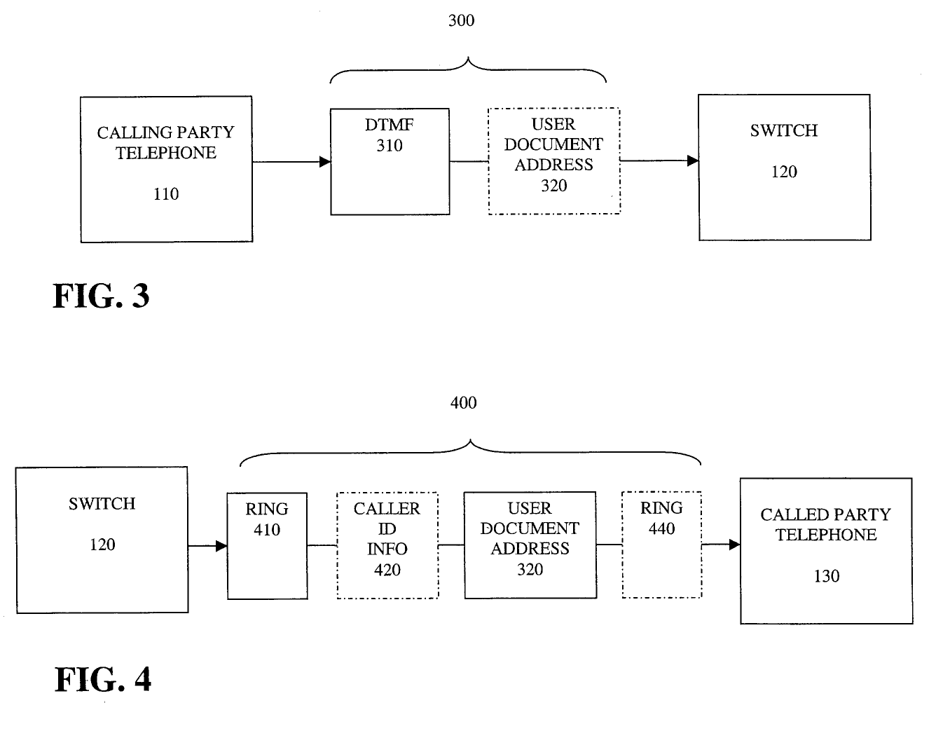

FIG. 3 illustrates an exemplary signal 300 transmitted from the calling party 110 to the switch 120 in accordance with one embodiment of the present invention. As shown in FIG. 3, the exemplary signal 300 sent by the telephone of the calling party 110 to the switch 120 includes dual tone multiple frequency (DTMF) tones 310 and a user document address 320. The DTMF tones 310 correspond to the telephone number of the called party 130, as entered by the calling party 110 using the keypad of the telephone, in a known manner. It is noted that the user document address 320 may be included in the signal 300 by the telephone of the calling party 110 or by the switch 120, as would be apparent to a person of ordinary skill in the art.

According to another aspect of the present invention, the user document identified by the address 320 can be (i) a static document created, for example, by the calling party 110 or someone on behalf of the calling party 110, such as a system administrator of the calling party 110; (ii) a default document created, for example, in accordance with a policy of the employer or telephone service provider of the calling party 110 (for example, a user document created in accordance with a default policy may always include the name, telephone number, photograph, corporate identifier and company logo of the calling party 110); or (iii) a dynamically generated document based on one or more rules. The dynamically generated document based on one or more rules may alter the content of the document based on various characteristics of the called party 130, such as corporate affiliation or geographic location, or characteristics of the call, such as time of day.

FIG. 4 illustrates an exemplary signal 400 transmitted by the switch 120 to the telephone of the called party 130 in accordance with one embodiment of the present invention. As shown in FIG. 4, the exemplary signal 400 generated by the switch 120 includes a user document address 320 in accordance with the present invention that accompanies one or more rings 410, 440, in addition to any conventional caller ID information 420. It is noted that the user document address 320 of the present invention may completely supercede any conventional caller ID information that is traditionally provided with the call.

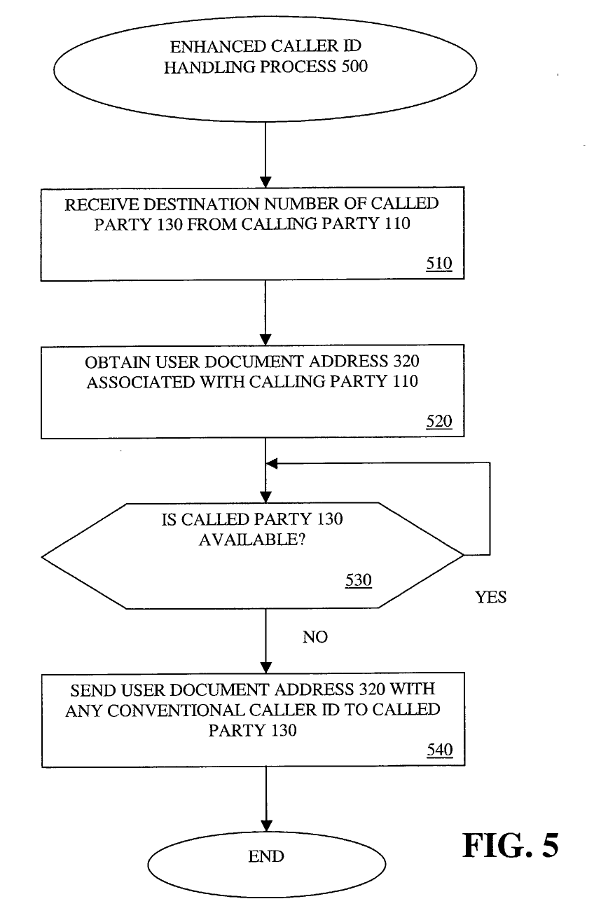

FIG. 5 is a flow chart describing an exemplary enhanced caller ID handling process 500 implemented by the switch 120 of FIG. 1. As shown in FIG. 5, the switch 120 initially receives the destination number of the called party 130 during step 510 and obtains the user document address 320 corresponding to the calling party 110 during step 520. As previously indicated, the user document address 320 may be stored by the calling party 110 and appended to the signal 300 or may be retrieved by the switch 120, as would be apparent to a person of ordinary skill in the art.

A test is performed during step 530 to determine if the telephone of the called party 130 identified by the received destination number is available. If it is determined during step 530 that the telephone of the called party 130 is not available, for example, if the telephone of the called party 130 is busy, then the switch 120 waits a predefined interval and retries the number or employs caller ID/calling waiting techniques. A message can be sent to the calling party 110 indicating that the called party 130 is not available and should wait while the switch 120 retries. The switch 120 can optionally call back the calling party 110 when the called party 130 becomes available.

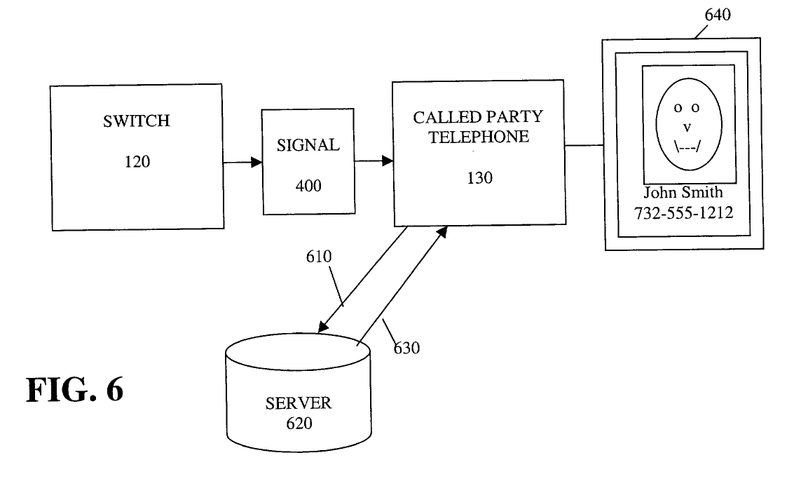

If, however, it is determined during step 530 that the telephone of the called party 130 is available, then the user document address 320 is sent with any conventional caller ID information in the signal 400 to the called party 130 (as shown in FIG. 4). The manner in which the user document address 320 and caller ID information is processed by the called party 130 is discussed in conjunction with FIG. 6.

As shown in FIG. 6, the called party 130 receives an incoming signal 400 from the switch 120 that includes a user document address 320 in addition to any conventional caller ID information, in accordance with the present invention. The telephone unit of the called party 130 retrieves the user document address 320 from the signal 400 and accesses the appropriate user document. In the exemplary implementation shown in FIG. 6, the called party 130 sends an HTTP request 610 for the user document to a server 620 addressed by the user document address 320. The server provides an HTTP response 620 with the requested user document. Thereafter, the requested user document is rendered to the called party 130, for example, on a display 640 associated with the telephone or another device of the called party 130. In this manner, the called party 130 obtains the URL specified by the calling party 110 from the web server 620 specified in the URL (user document address 320) and displays the content of the URL to the called party 130.

For example, the user document address 320 may be a URL, such as http://www.abccorp.com/corporate_directory/personA, that is resolved by a domain name server (DNS) to the server 620. The appropriate document is then provided to the called party 130 in accordance with the HTTP protocol for presentation to the called party 130, for example, on a display associated with the telephone or another device of the called party 130. It is noted that while the exemplary embodiments described herein contemplate the use of textual or image-based user documents, the user documents may also be embodied using other media, such as audio, in addition to or instead of text or image information.

It is to be understood that the embodiments and variations shown and described herein are merely illustrative of the principles of this invention and that various modifications may be implemented by those skilled in the art without departing from the scope and spirit of the invention.

We claim:

1. A method for providing caller ID information with a call to a called party, comprising:
obtaining a user document address associated with a calling party, said user document address identifying a user document that should be presented to said called party; and
providing said user document address to said called party with said call.

2. The method of claim 1, wherein said user document address is a uniform resource locator.

3. The method of claim 1, wherein said user document is a static document associated with said calling party.

4. The method of claim 1, wherein said user document is a default document created in accordance with predefined default document content rules.

5. The method of claim 1, wherein said user document is a dynamic document based on one or more rules that alter the content of said user document.

6. The method of claim 1, wherein said user document address is received from said calling party with said call.

7. The method of claim 1, wherein said user document address is obtained from a local database of users.

8. The method of claim 1, wherein said user document comprises one or more media.

9. A method for providing caller ID information with a call to a called party, comprising:
receiving said call from a switch, said call including a user document address associated with a calling party, said user document address identifying a document that should be presented to said called party;
obtaining a user document identified by said user document address; and
presenting said user document to said called party.

10. The method of claim 9, wherein said user document address is a uniform resource locator.

11. The method of claim 9, wherein said user document is a static document associated with said calling party.

12. The method of claim 9, wherein said user document is a default document created in accordance with predefined default document content rules.

13. The method of claim 9, wherein said user document is a dynamic document based on one or more rules that alter the content of said user document.

14. A system for providing caller ID information with a call to a called party, comprising:
a memory that stores computer-readable code; and
a processor operatively coupled to said memory, said processor configured to implement said computer-readable code, said computer-readable code configured to:
obtain a user document address associated with a calling party, said user document address identifying a document that should be presented to said called party; and
provide said user document address to said called party with said call.

15. The system of claim 14, wherein said user document address is a uniform resource locator.

16. The system of claim 14, wherein said user document address is received from said calling party with said call.

17. The system of claim 14, wherein said user document address is obtained from a local database of users.

18. A system for presenting caller ID information with a call to a called party, comprising:
a memory that stores computer-readable code; and
a processor operatively coupled to said memory, said processor configured to implement said computer-readable code, said computer-readable code configured to:
receive said call from a switch, said call including a user document address associated with a calling party, said user document address identifying a document that should be presented to said called party;
obtain a user document identified by said user document address; and
present said user document to said called party.

19. The system of claim 18, wherein said user document address is a uniform resource locator.

20. An article of manufacture for providing caller ID information with a call to a called party, comprising:
a computer readable medium having computer readable code means embodied thereon, said computer readable program code means comprising:
a step to receive a destination number identifying said called party;
a step to obtain a user document address associated with a calling party, said user document address identifying a document that should be presented to said called party; and
a step to provide said user document address to said called party with said call.

21. An article of manufacture for presenting caller ID information with a call to a called party, comprising:
a computer readable medium having computer readable code means embodied thereon, said computer readable program code means comprising:
a step to receive said call from a switch, said call including a user document address associated with a calling party, said user document address identifying a document that should be presented to said called party;
a step to obtain a user document identified by said user document address; and
a step to present said user document to said called party.
